(19) United States
(12) Patent Application Publication
(10) Pub. No.: US 2025/0239040 A1
(43) Pub. Date: Jul. 24, 2025

(54) AUTOMATICALLY DETERMINING WHETHER AN OBJECT OF INTEREST IS IN THE CENTER OF FOCUS

(71) Applicant: Microsoft Technology Licensing, LLC, Redmond, WA (US)

(72) Inventors: Aleksander Bogdan BAPST, San Diego, CA (US); Antonios MATAKOS, Redmond, WA (US); Qi ZHANG, Gig Harbor, WA (US)

(21) Appl. No.: 18/419,061

(22) Filed: Jan. 22, 2024

(51) Int. Cl. G06V 10/22; G06V 10/26

(52) U.S. Cl. CPC G06V 10/22; G06V 10/26

(57) ABSTRACT

Techniques for determining whether an object of interest (OOI) is the center of focus are described herein. An image of an environment is obtained. This image includes pixel content representative of the OOI. Pose data for the camera that generated the image is obtained. A bounding element is generated and surrounds the pixel content that represents the OOI. Subsequently, a segmentation process is performed on the pixels surrounded by the bounding element. This segmentation identifies pixels that represent the OOI and pixels that do not represent the OOI. This segmentation also identifies a silhouette of the OOI. A determination is made as to whether the pixels that represent the OOI are at the center of focus.

### BACKGROUND

Head mounted devices (HMD), or other wearable devices, are becoming highly popular. These types of devices are able to provide a so-called “extended reality” experience.

The phrase “extended reality” (XR) is an umbrella term that collectively describes various different types of immersive platforms. Such immersive platforms include virtual reality (VR) platforms, mixed reality (MR) platforms, and augmented reality (AR) platforms. The XR system provides a “scene” to a user. As used herein, the term “scene” generally refers to any simulated environment (e.g., three-dimensional (3D) or two-dimensional (2D)) that is displayed by an XR system.

For reference, conventional VR systems create completely immersive experiences by restricting their users' views to only virtual environments. This is often achieved through the use of an HMD that completely blocks any view of the real world. Conventional AR systems create an augmented-reality experience by visually presenting virtual objects that are placed in the real world. Conventional MR systems also create an augmented-reality experience by visually presenting virtual objects that are placed in the real world, and those virtual objects are typically able to be interacted with by the user. Furthermore, virtual objects in the context of MR systems can also interact with real world objects. AR and MR platforms can also be implemented using an HMD. XR systems can also be implemented using laptops, handheld devices, HMDs, and other computing systems.

Unless stated otherwise, the descriptions herein apply equally to all types of XR systems, which include MR systems, VR systems, AR systems, and/or any other similar system capable of displaying virtual content. An XR system can be used to display various different types of information to a user. Some of that information is displayed in the form of a “hologram.” As used herein, the term “hologram” generally refers to image content that is displayed by an XR system. In some instances, the hologram can have the appearance of being a 3D object while in other instances the hologram can have the appearance of being a 2D object. In some instances, a hologram can also be implemented in the form of an image displayed to a user.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

In some aspects, the techniques described herein relate to a computer system including: a processor system; and a storage system including instructions that are executable by the processor system to cause the computer system to: obtain an image of an environment in which an object of interest (OOI) is located, wherein the image includes pixel content representative of the OOI, the image being generated by a camera; obtain pose data for the camera, the pose data representing a pose of the camera when the camera generated the image; perform target detection on the image by generating a bounding element that surrounds the pixel content that is representative of the OOI; subsequent to performing the target detection, perform target segmentation on pixels surrounded by the bounding element, wherein the target segmentation identifies pixels that represent the OOI and pixels that do not represent the OOI, and wherein the target segmentation identifies a silhouette of the OOI; and determine whether a reticle associated with the camera overlaps the pixels that represent the OOI within the image.

In some aspects, the techniques described herein relate to a method including: obtaining an image of an environment in which an object of interest (OOI) is located, wherein the image includes pixel content representative of the OOI, the image being generated by a camera; obtaining pose data for the camera, the pose data representing a pose of the camera when the camera generated the image; performing target detection on the image by generating a bounding element that surrounds the pixel content that is representative of the OOI; subsequent to performing the target detection, performing target segmentation on pixels surrounded by the bounding element, wherein the target segmentation identifies pixels that represent the OOI and pixels that do not represent the OOI, and wherein the target segmentation identifies a silhouette of the OOI; and determining whether a reticle associated with the camera overlaps the pixels that represent the OOI within the image.

In some aspects, the techniques described herein relate to a computer system including: a processor system; and a storage system including instructions that are executable by the processor system to cause the computer system to: obtain an image of an environment in which an object of interest (OOI) is located, wherein the image includes pixel content representative of the OOI, the image being generated by a camera; obtain pose data for the camera, the pose data representing a pose of the camera when the camera generated the image; perform target detection on the image by generating a bounding element that surrounds the pixel content that is representative of the OOI; subsequent to performing the target detection, perform target segmentation on pixels surrounded by the bounding element, wherein the target segmentation identifies pixels that represent the OOI and pixels that do not represent the OOI, and wherein the target segmentation identifies a silhouette of the OOI; determine that a center portion of a reticle, which is associated with the camera, overlaps the pixels that represent the OOI within the image; display the image and the reticle on a display of the computer system; and display an indication that the OOI has been targeted as a result of the center portion of the reticle overlapping the pixels that represent the OOI at the specified instant in time.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example computing architecture that can determine whether an object of interest in in focus.

FIG. 2 illustrates an example HMD.

FIG. 3 illustrates an example gaming environment.

FIG. 4 illustrates another example gaming environment.

FIG. 5 illustrates different cameras and their fields of view (FOVs).

FIG. 6 illustrates an example of an overlaid image.

FIG. 7 illustrates an example of an image that includes objects of interest.

FIG. 8 illustrates an example of an overlaid image.

FIG. 9 illustrates an example of a stage one target detection process.

FIG. 10 illustrates an example of a stage two target segmentation process.

FIG. 11 illustrates the display of a reticle.

FIG. 12 illustrates another display of the reticle.

FIG. 13 illustrates another display of the reticle.

FIG. 14 illustrates an example of operations performed by a graph cut algorithm.

FIG. 15 illustrates an example histogram of a thermal image.

FIG. 16 illustrates a flowchart of an example method for determining whether an object of interest is currently in the center of focus.

FIG. 17 illustrates an example computer system that can be configured to perform any of the disclosed operations.

### DETAILED DESCRIPTION

The disclosed embodiments are beneficially able to determine whether an object of interest (OOI) is currently in the center of focus, or rather, is being focused on by a camera or by a tool associated with the camera. To do so, the embodiments obtain an image of an environment. This image includes pixel content representative of the OOI. The embodiments obtain pose data for the camera that generated the image. The embodiments generate a bounding element structure to surround the pixel content that represents the OOI. Subsequently, the embodiments implement a segmentation process on the pixels surrounded by the bounding element. This segmentation identifies pixels that represent the OOI and pixels that do not represent the OOI. This segmentation also identifies a silhouette of the OOI. The embodiments determine whether the pixels that represent the OOI are at the center of focus.

In performing the disclosed operations, significant benefits, improvements, and practical applications can be achieved. As one benefit, the embodiments are able to generate an enhanced image that includes content obtained from multiple different images. These different images may be generated by cameras of differing modalities. Thus, different types of imagery can be overlaid on one another, resulting in the generation of an enhanced image. Another benefit involves improved image analysis, improved computing efficiency, and improved user interaction with the computer system, all of which will be discussed in more detail throughout the remaining portions of this disclosure.

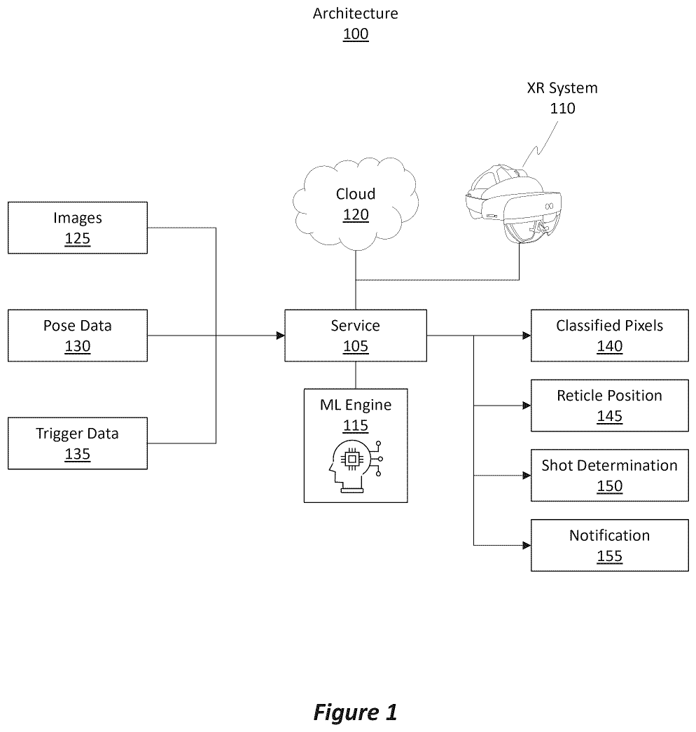

Having just described some of the high level benefits, advantages, and practical applications achieved by the disclosed embodiments, attention will now be directed to FIG. 1, which illustrates an example computing architecture 100 that can be used to achieve those benefits.

Architecture 100 includes a service 105, which can be implemented by an XR system 110 comprising an HMD. As used herein, the phrases XR system, HMD, platform, or wearable device can all be used interchangeably and generally refer to a type of system that displays holographic content (i.e. holograms). In some cases, XR system 110 is of a type that allows a user to see various portions of the real world and that also displays virtualized content in the form of holograms. That ability means XR system 110 is able to provide so-called “passthrough images” to the user. It is typically the case that architecture 100 is implemented on an MR or AR system, though it can also be implemented in a VR system.

As used herein, the term “service” refers to an automated program that is tasked with performing different actions based on input. In some cases, service 105 can be a deterministic service that operates fully given a set of inputs and without a randomization factor. In other cases, service 105 can be or can include a machine learning (ML) or artificial intelligence engine, such as ML engine 115. The ML engine 115 enables the service to operate even when faced with a randomization factor.

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 105 is a cloud service operating in a cloud 120 environment. In some implementations, service 105 is a local service operating on a local device, such as the XR system 110. In some implementations, service 105 is a hybrid service that includes a cloud component operating in the cloud 120 and a local component operating on a local device. These two components can communicate with one another.

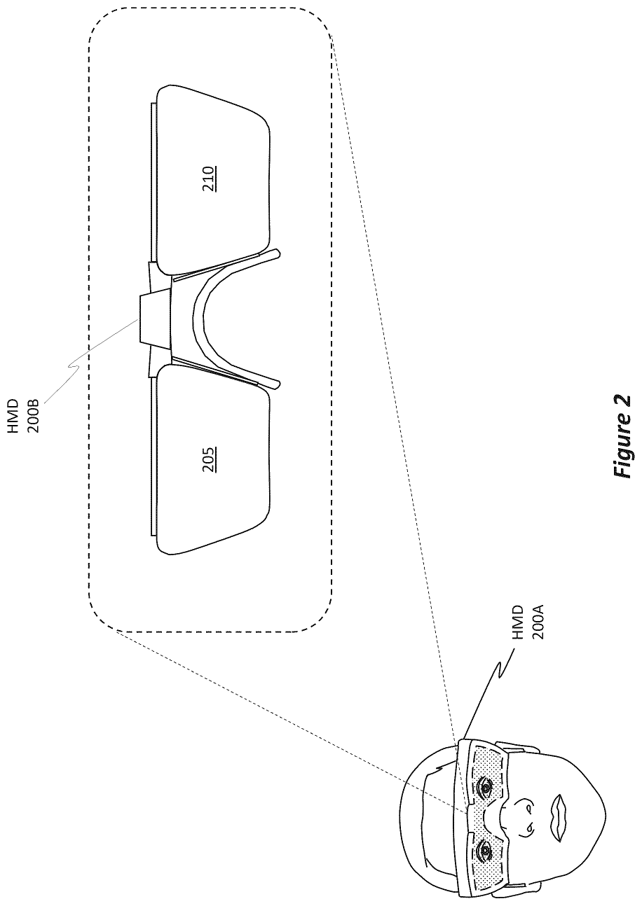

Turning briefly to FIG. 2, HMDs 200A and 200B are shown, where these HMDs are representative of the XR system 110 of FIG. 1. HMD 200B includes a left display 205, and a right display 210. HMD 200B is thus configured to provide binocular vision to the user. That is, HMD 200B displays a first image in the left display 205 and a second, different image in the right display 210. The user will view these two separate images, and the user's mind can fuse them, thereby allowing the user to perceive depth with respect to the holograms.

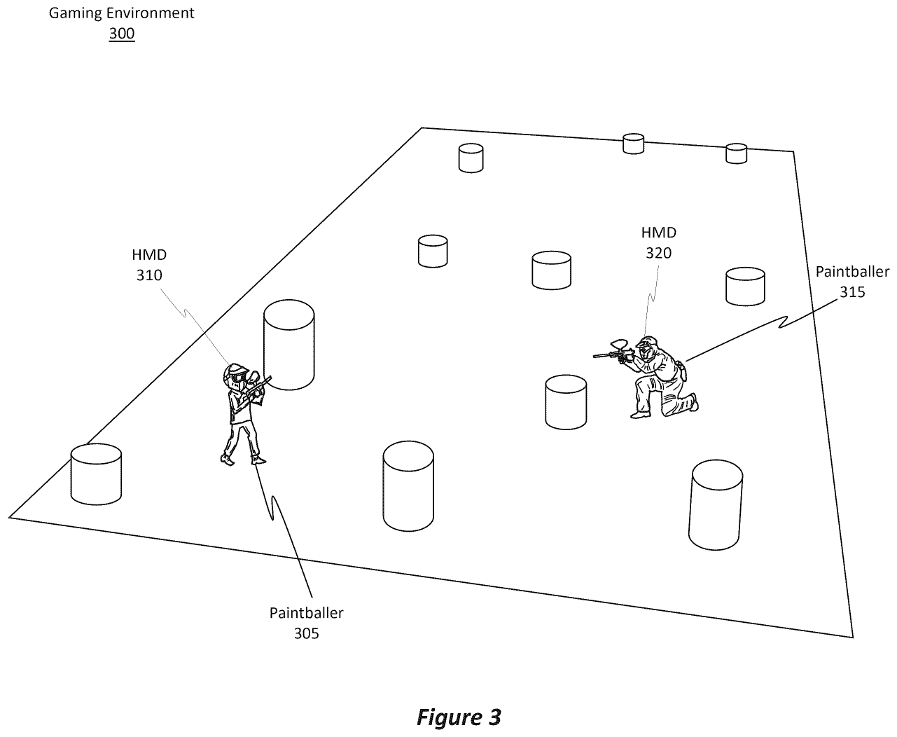

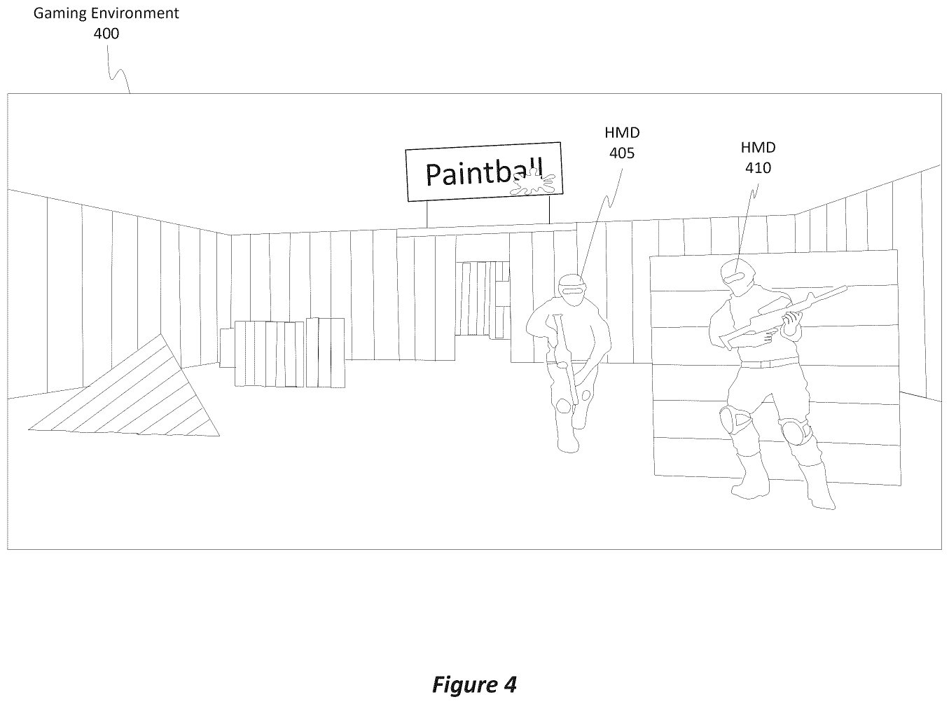

HMDs can be used in a variety of scenarios, including gaming scenarios, workplace scenarios, indoor or outdoor scenarios, or home scenarios. Indeed, HMDs can be used almost anywhere. FIGS. 3 and 4 illustrate various different gaming environments in which an HMD can be used.

For instance, FIG. 3 shows a first gaming environment 300 in which multiple users are wearing HMDs and are playing paintball. To illustrate, FIG. 3 shows a paintballer 305 wearing an HMD 310 and a second paintballer 315 wearing an HMD 320. The HMDs can assist these players in their performance of the paintball game.

Similarly, FIG. 4 shows a gaming environment 400 that is also a paintball game, or perhaps an airsoft or other competitive game in which multiple individuals are engaged. FIG. 4 shows a first player wearing an HMD 405 and a second player wearing an HMD 410.

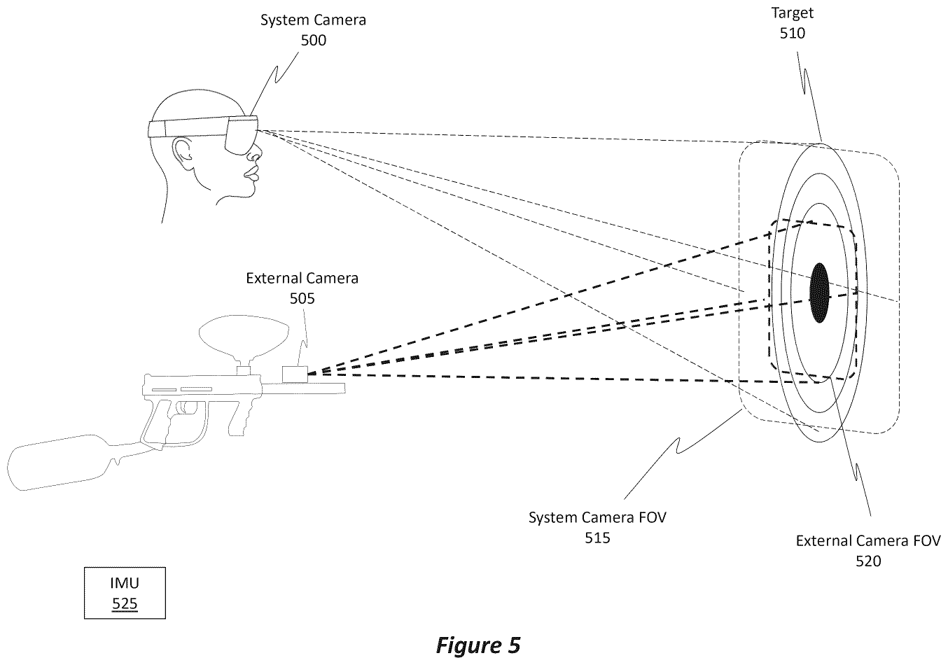

With those gaming scenarios in mind, FIG. 5 shows a system camera 500 mounted on an HMD and a tool (e.g., a paintball gun) that includes an external camera 505. It should be noted how the optical axis of the external camera 505 is aligned with the aiming direction of the tool. As a consequence, the images generated by the external camera 505 can be used to determine where the tool is being aimed. One will appreciate how the tool can be any type of aimable tool, without limit.

In FIG. 5, both the system camera 500 and the external camera 505 are being aimed at a target 510. To illustrate, the field of view (FOV) of the system camera 500 is represented by the system camera FOV 515, and the FOV of the external camera 505 is represented by the external camera FOV 520. Notice, the system camera FOV 515 is larger than the external camera FOV 520. Typically, the external camera 505 provides a very focused view, similar to that of a scope (i.e. a high level of angular resolution). Optionally, the external camera 505 can sacrifice a wide FOV for an increased resolution and increased pixel density. Accordingly, in this example scenario, one can observe how in at least some situations, the external camera FOV 520 may be entirely overlapped or encompassed by the system camera FOV 515. Of course, in the event the user aims the external camera 505 in a direction where the system camera 500 is not aimed at, then the system camera FOV 515 and the external camera FOV 520 will not overlap.

FIG. 5 also shows an inertial measurement unit (IMU) 525. Notably, the system camera 500 may include or be associated with a first IMU, and the external camera 505 may include or be associated with a second IMU. These IMUs generate IMU data, and the IMU data can optionally be used to determine the absolute pose or orientation of the system camera 500 and the external camera 505, and even the relative poses between the system camera 500 and the external camera 505.

Returning to FIG. 1, service 105 can access any number of images 125. These images 125 may be of any type. For instance, these images 125 may include red-green-blue (RGB) visible light images, low light images, and/or thermal images. These images 125 may be generated by RGB cameras, low light cameras, and/or thermal cameras. For instance, the system camera 500 of FIG. 5 may be an RGB camera, a low light camera, and/or a thermal camera, and the system camera 500 can generate any number of images. Similarly, the external camera 505 of FIG. 5 may be an RGB camera, a low light camera, and/or a thermal camera, and the external camera 505 can generate any number of images. Thus, the images 125 may include any number of images from the system camera 500 and/or the external camera 505.

Service 105 is also able to access or otherwise generate pose data 130 for the cameras that generated for the images 125. As one example, service 105 can access the IMU data generated by the IMU associated with system camera 500. Similarly, service 105 can access the IMU data generated by the IMU associated with the external camera 505. Using this IMU data, service 105 can determine the absolute and/or relative poses of the cameras.

As will be described in more detail shortly, service 105 can further access or generate trigger data 135. Using the example of FIG. 5, the trigger data 135 reflects when the trigger of the tool (e.g., the paintball gun) is pulled. This trigger data 135 can include switch information, such as in a scenario where the trigger of the tool includes a switch feature that activates when the trigger is pulled. This trigger data 135 can also or alternatively include IMU data indicative of tool's kickback. In any event, service 105 is able to determine an instant in time when the tool's trigger is pulled. Additionally, the embodiments are able to trigger the snapshot or generation of an image (included among the images 125) when the trigger is pulled. Thus, the timestamp of the images 125 can align or coincide with the timestamp of the trigger data 135. Additionally, the embodiments are able to determine the pose of the tool when the trigger was pulled. Thus, the timestamps of the images 125, the pose data 130, and the trigger data 135 may all coincide.

Turning briefly to FIG. 5 again, the images generated by the system camera 500 have a resolution and are captured by the system camera based on a determined refresh rate of the system camera 500. The refresh rate of the system camera 500 is typically between about 30 Hz and 120 Hz. Often, the refresh rate is around 90 Hz or at least 60 Hz. Often, the field of view (FOV) of the system camera has at least a 55 degree horizontal FOV. The horizontal baseline of the system camera's FOV may extend to 65 degrees, or even beyond 65 degrees.

As mentioned, the HMD includes an IMU. An IMU is a type of device that measures forces, angular rates, and orientations of a body. An IMU can use a combination of accelerometers, magnetometers, and gyroscopes to detect these forces. Because both the system camera and the IMU are integrated with the HMD, the IMU can be used to determine the orientation or pose of the system camera (and the HMD) as well as any forces the system camera is being subjected to.

In some cases, the “pose” may include information detailing the 6 degrees of freedom, or “6 DOF,” information. Generally, the 6 DOF pose refers to the movement or position of an object in three-dimensional space. The 6 DOF pose includes surge (i.e. forward and backward in the x-axis direction), heave (i.e. up and down in the z-axis direction), and sway (i.e. left and right in the y-axis direction). In this regard, 6 DOF pose refers to the combination of 3 translations and 3 rotations. Any possible movement of a body can be expressed using the 6 DOF pose.

In some cases, the pose may include information detailing the 3 DOF pose. Generally, the 3 DOF pose refers to tracking rotational motion only, such as pitch (i.e. the transverse axis), yaw (i.e. the normal axis), and roll (i.e. the longitudinal axis). The 3 DOF pose allows the HMD to track rotational motion but not translational movement of itself and of the system camera. As a further explanation, the 3 DOF pose allows the HMD to determine whether a user (who is wearing the HMD) is looking left or right, whether the user is rotating his/her head up or down, or whether the user is pivoting left or right. In contrast to the 6 DOF pose, when 3 DOF pose is used, the HMD is not able to determine whether the user (or system camera) has moved in a translational manner, such as by moving to a new location in the environment.

Determining the 6 DOF pose and the 3 DOF pose can be performed using inbuilt sensors, such as accelerometers, gyroscopes, and magnetometers (i.e. the IMU). Determining the 6 DOF pose can also be performed using positional tracking sensors, such as head tracking sensors. Accordingly, the IMU can be used to determine the pose of the HMD.

FIG. 5 shows the external camera FOV 520. Notice, the external camera FOV 520 is smaller than the system camera FOV 515. That is, the angular resolution of the external camera FOV 520 is higher than the angular resolution of the system camera FOV 515. Having an increased angular resolution also results in the pixel density of an external camera image being higher than the pixel density of a system camera image. For instance, the pixel density of an external camera image is often 2.5 to 3 times that of the pixel density of a system camera image. As a consequence, the resolution of an external camera image is higher than the resolution of the system camera image. Often, the external camera FOV 520 has at least a 19 degree horizontal FOV. That horizontal baseline may be higher, such as 20 degrees, 25 degrees, 30 degrees, or more than 30 degrees.

The external camera also has a refresh rate. The refresh rate of the external camera is typically lower than the refresh rate of the system camera. For example, the refresh rate of the external camera is often between 20 Hz and 60 Hz. Typically, the refresh rate of the external camera is at least about 30 Hz. The refresh rate of the system camera is often different than the refresh rate of the external camera. In some cases, however, the two refresh rates may be substantially the same.

The external camera also includes or is associated with an IMU. Using this IMU, the embodiments are able to detect or determine the orientation/pose of the external camera as well as any forces that the external camera is being subjected to. Accordingly, similar to the earlier discussion, the IMU can be used to determine the pose (e.g., 6 DOF and/or 3 DOF) of the external camera sight.

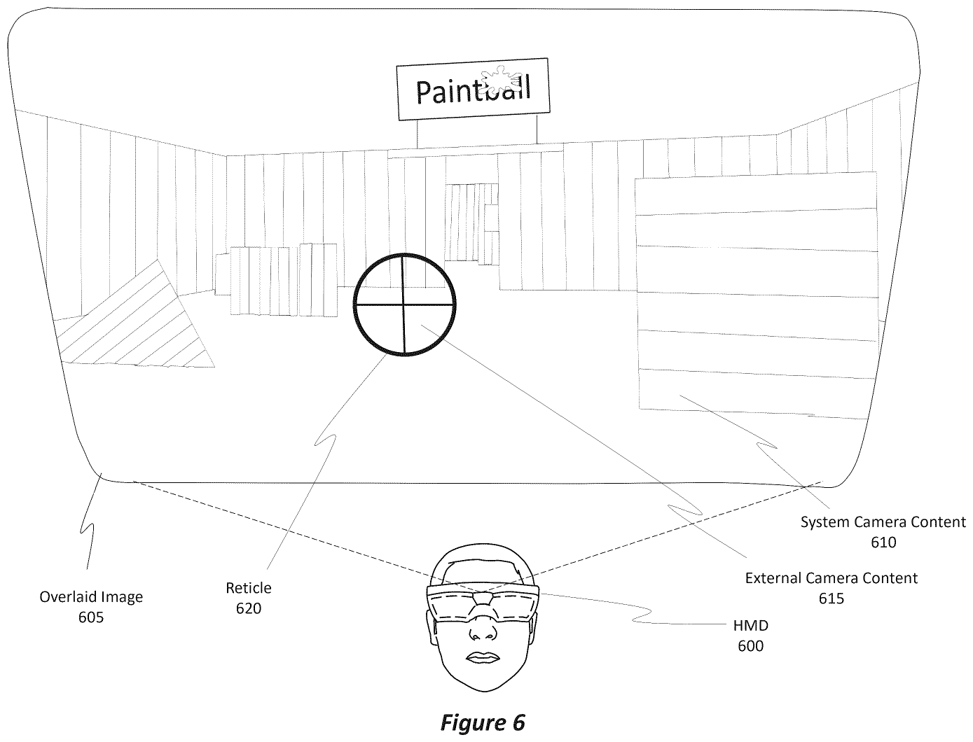

Some embodiments are designed to generate an overlaid image. That is, some embodiments overlap and align the images obtained from the external camera with the images generated by the system camera to generate an overlaid and aligned passthrough image. The overlap (in terms of FOV) between the two images enables the embodiments to generate multiple images and then overlay image content from one image onto another image in order to generate a composite image or an overlaid image having enhanced features that would not be present if only a single image were used. As one example, the system camera image provides a broad FOV while the external camera image provides high resolution and pixel density for a focused area (i.e. the aiming area where the tool is being aimed). By combining the two images, the resulting image will have the benefits of a broad FOV and a high pixel density for the aiming area. FIG. 6 is illustrative.

FIG. 6 shows an HMD 600 that is representative of the HMDs discussed thus far. HMD 600 is displaying an overlaid image 605, which includes content obtained from the system camera, as shown by system camera content 610, and content obtained from the external camera, as shown by external camera content 615. In this example, a bounding element in the form of a reticle 620 is also displayed, and this bounding element encompasses or surrounds the external camera content 615. Further details on this overlaid image will be provided later.

It should be noted that while this disclosure primarily focuses on the use of two images (e.g., the system camera image and the external camera image), the embodiments are able to align content from more than two images having overlapping regions. For instance, suppose 2, 3, 4, 5, 6, 7, 8, 9, or even 10 integrated and/or detached cameras have overlapping FOVs. The embodiments are able to examine each resulting image and then align specific portions with one another. The resulting overlaid image may then be a composite image formed from any combination or alignment of the available images (e.g., even 10 or more images, if available). Accordingly, the embodiments are able to utilize any number of images when performing the disclosed operations and are not limited to only two images or two cameras.

As another example, suppose the system camera is a low light camera and further suppose the external camera is a thermal imaging camera. As will be discussed in more detail later, the embodiments are able to selectively extract image content from the thermal imaging camera image and overlay that image content onto the low light camera image. In this regard, the thermal imaging content can be used to augment or supplement the low light image content, thereby providing enhanced imagery to the user. Additionally, because the external camera has increased resolution relative to the system camera, the resulting overlaid image will provide enhanced clarity for the areas where the pixels in the external camera image are overlaid onto the system camera image.

As mentioned above, the embodiments are able to align the system camera's image with the external camera's image. That is, because at least a portion of the two cameras' FOVs overlap with one another, as was described earlier, at least a portion of the resulting images include corresponding content. Consequently, that corresponding content can be identified and then a merged, fused, or overlaid image can be generated based on the similar corresponding content. By generating this overlaid image, the embodiments are able to provide enhanced image content to the user, which enhanced image content would not be available if only a single image type were provided to a user. Both the system camera's image and the external camera's images may be referred to as “texture” images.

To merge or align the images, the embodiments are able to analyze the texture images (e.g., perform computer vision feature detection) in an attempt to find any number of feature points. As used herein, the phrase “feature detection” generally refers to the process of computing image abstractions and then determining whether an image feature (e.g., of a particular type) is present at any particular point or pixel in the image. Often, corners (e.g., the corners of a wall), distinguishable edges (e.g., the edge of a table), or ridges are used as feature points because of the inherent or sharp contrasting visualization of an edge or corner.

Any type of feature detector may be programmed to identify feature points. In some cases, the feature detector may be a machine learning algorithm.

In accordance with the disclosed principles, the embodiments detect any number of feature points (e.g., 1, 2, 3, 4, 5, 6, 7, 8, 9, 10, 20, 30, 40, 50, 60, 70, 80, 90, 100, 200, 500, 1,000, 2,000, or more than 2,000) and then attempt to identify correlations or correspondences between the feature points detected in the system camera image and the feature points identified in the external camera image.

Some embodiments then fit the feature or image correspondence(s) to a motion model in order to overlay one image onto another image to form an enhanced overlaid image. Any type of motion model may be used. Generally, a motion model is a type of transformation matrix that enables a model, a known scene, or an object to be projected onto a different model, scene, or object.

In some cases, the motion model may simply be a rotational motion model. With a rotational model, the embodiments are able to shift one image by any number of pixels (e.g., perhaps 5 pixels to the left and 10 pixels up) in order to overlay one image onto another image. For instance, once the image correspondences are identified, the embodiments can identify the pixel coordinates of those feature points or correspondences. Once the coordinates are identified, then the embodiments can overlay the external camera sight's image onto the HMD camera's image using the rotational motion model approach described above.

In some cases, the motion model may be more complex, such as in the form of a similarity transform model. The similarity transform model may be configured to allow for (i) rotation of either one of the HMD camera's image or the external camera sight's image, (ii) scaling of those images, or (iii) homographic transformations of those images. In this regard, the similarity transform model approach may be used to overlay image content from one image onto another image. Accordingly, in some cases, the process of aligning the external camera image with the system camera image is performed by (i) identifying image correspondences between the images and then, (ii) based on the identified image correspondences, fitting the correspondences to a motion model such that the external camera image is projected onto the system camera image.

Another technique for aligning images includes using IMU data to predict poses of the system camera and the external camera. Once the two poses are estimated or determined, the embodiments then use those poses to align one or more portions of the images with one another. Once aligned, then one or more portions of one image (which portions are the aligned portions) are overlaid onto the corresponding portions of the other image in order to generate an enhanced overlaid image. In this regard, IMUs can be used to determine poses of the corresponding cameras, and those poses can then be used to perform the alignment processes.

FIG. 6 shows a resulting overlaid image 605 comprising portions (or all) of a system camera image (i.e. an image generated by the system camera) and an external camera image (i.e. an image generated by the external camera). Optionally, additional image artifacts can be included in the overlaid image 605, such as the reticle 620 which is used to help the user aim the tool. By aligning the image content, a user of the tool can determine where the tool is being aimed without having to look down the tool's sights. Instead, the user can discern where the tool is being aimed by simply looking at the content displayed in his/her HMD.

Providing the enhanced overlaid image 605 allows for rapid target acquisition. That is, a target can be acquired (i.e. the tool is accurately aimed at a desired target) in a fast manner because the user no longer has to take time to look through the tool's sights.

Returning to FIG. 1, service 105 is tasked with performing various operations. In particular, service 105 obtains an image (e.g., the images 125, including perhaps an overlaid image) of an environment in which an object of interest (OOI) is located. Notably, the image includes pixel content representative of the OOI, and the image is generated by one or more cameras.

Service 105 then obtains pose data (e.g., pose data 130) for the camera. The pose data represents a pose of the camera when the camera generated the image.

Service 105 performs target detection on the image by generating a bounding element that surrounds the pixel content that is representative of the OOI. Subsequent to performing the target detection, service 105 performs target segmentation on pixels surrounded by the bounding element. The target segmentation identifies pixels that represent the OOI and pixels that do not represent the OOI. Optionally, the target segmentation identifies a silhouette of the OOI. As a consequence, service 105 is able to identify and classify the pixels in the image, as shown by the classified pixels 140.

At a specified instant in time (e.g., when the trigger of the tool is pulled), service 105 then determines whether a reticle associated with the camera overlaps the pixels that represent the OOI within the image. For instance, service 105 is able to determine the reticle position 145. In doing so, service 105 is able to determine whether the user's shot was properly directed to the OOI. For instance, service 105 is able to determine whether the user's shot landed, as shown by shot determination 150. When the embodiments are being used in a gaming scenario in which multiple members are participating and are using HMDs, a notification 155 regarding a successful shot can be transmitted and displayed to whichever user was the subject of the shot. That notification can optionally elaborate on which specific body part was the target of the shot. In the gaming scenario, this notification can be used to determine whether a player should no longer continue with the gameplay.

By way of an additional example, consider a force-on-force combat training system (e.g., paintball) that consists of a set of participants taking part in a training session. The participants can be equipped with (1) a global positioning system (GPS), (2) a transmitting device, and (3) a thermal (or infrared) imaging camera or scope mounted to the ends of their mock training tools. When a participant takes a shot, an image from the sensor is obtained (e.g., sent to service 105), along with potentially the GPS position and the orientation of the participant. Service 105 (which may be on-premises, off-site, or running on a computing device, such as the HMD) collects images corresponding to shots taken. During a training session, and after the session is completed, participants and observers may view the images on a terminal and mark the images for accuracy, (e.g., “hit” or “miss” for the purposes of generating an after-action report and assessing performance).

The disclosed embodiments beneficially address the problem of marking images collected during target practice. The embodiments assign labels determining whether a shot hits a target or not. While a human may manually mark the images, this process is tedious and time consuming. Computer vision is ideally suited to automating such a task.

The embodiments relate to a two-stage hierarchical algorithm that combines supervised object detection with adaptive unsupervised object segmentation to solve the above problem efficiently and without the need for user input. Furthermore, the properties of thermal imagery can optionally be leveraged; namely, the strong contrast between warm (foreground) and cold (background) targets makes such images well-suited to energy minimization methods such as graph cuts.

In this sense, architecture 100 of FIG. 1 generally describes a system that wirelessly collects images (e.g., infrared) of shots taken by participants in a target practice session (e.g., perhaps a night time session). The system automatically determines if a shot taken by a participant was a hit or a miss and makes decisions without human intervention about whether to exclude a participant from the training session. These decisions are made in near-real time.

This two-stage approach of automatically determining if a shot image collected by the system was a hit or a miss includes a supervised object detection stage (e.g., stage one) and an unsupervised foreground-background segmentation stage (e.g., stage two) in which the detections from the first stage are further processed to obtain a silhouette of the detected target. Additionally, the embodiments adaptively select an intensity threshold to prime the foreground-background segmentation algorithm of stage two without any user input.

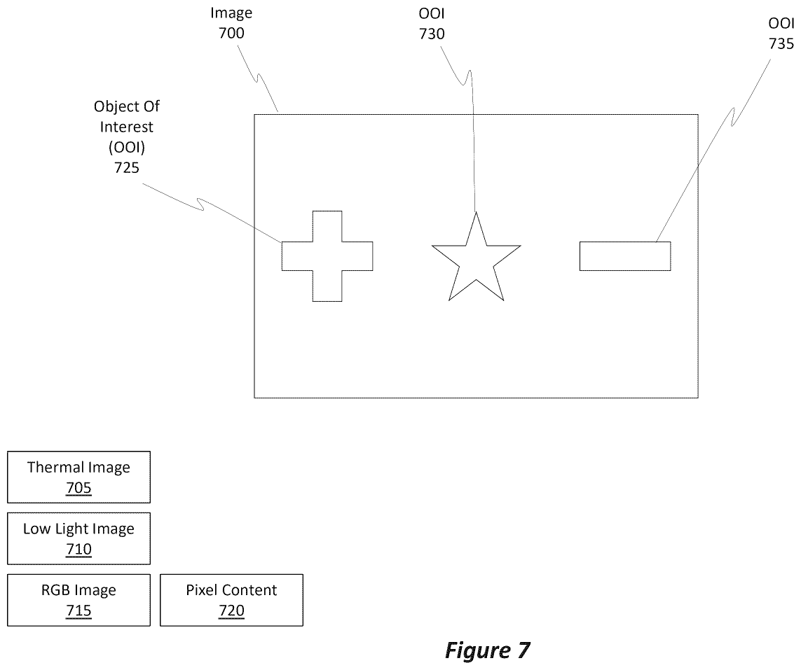

Optionally, the embodiments may include information about the position and orientation of participants as well as environmental conditions such as wind speed and direction when a shot was taken. Obtaining this additional information is beneficial because it helps to further verify the hit/miss decisions. This additional information can also be used to augment those decisions to include the identity of the participants involved and to correct the expected location of the aiming reticle to account for prevailing conditions. FIGS. 7 through 15 provide some additional examples and explanations regarding the disclosed embodiments.

FIG. 7 shows an example image 700 that may be included among the images 125 of FIG. 1. Image 700 may be a standalone image or it may be an overlaid image, as mentioned previously. Image 700 may be a thermal image 705, a low light image 710, or an RGB image 715.

Image 700 includes pixel content 720 that represents various OOIs. For instance, a first group of pixels represent an OOI 725. A second group of pixels represent an OOI 730. A third group of pixels represent an OOI 735.

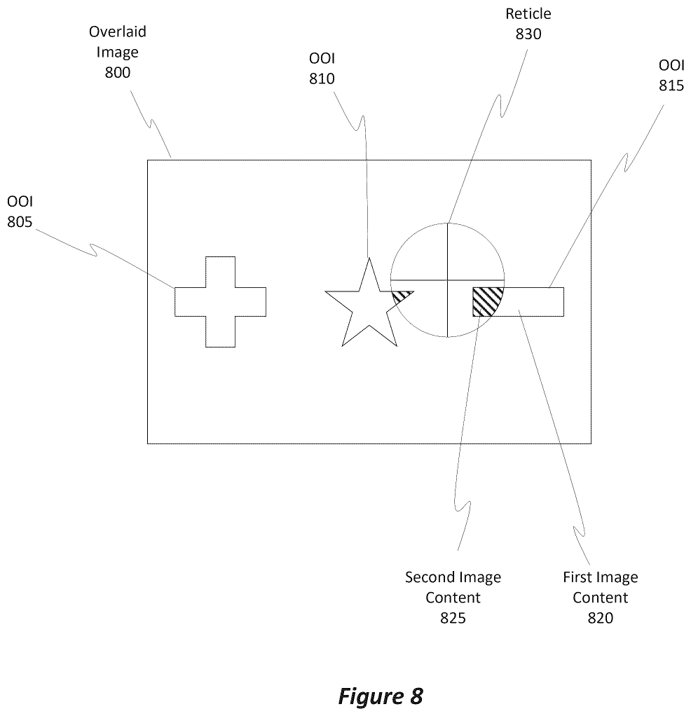

FIG. 8 shows an overlaid image 800 that includes content obtained from multiple different images. Overlaid image 800 includes pixel content that represents an OOI 805, an OOI 810, and an OOI 815. Pixel content obtained from the first image is labeled as first image content 820. Pixel content obtained from the second image is labeled as second image content 825 and is visually illustrated using the diagonal lines. Notice, a portion of the star and a portion of the rectangle are obtained from the second image. A bounding element in the form of a reticle 830 encompasses the pixel content obtained from the second image.

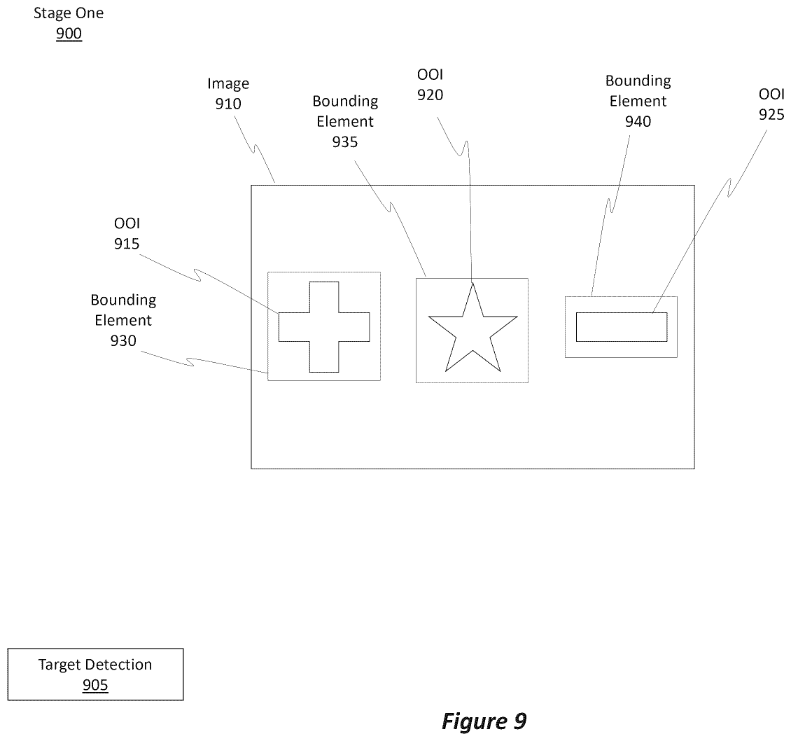

FIG. 9 shows a set of stage one 900 operations that are performed by the service 105 of FIG. 1. Stage one 900 includes the target detection 905 operations in which objects of interest are generally identified within an image. To illustrate, FIG. 9 shows an image 910, which includes OOIs 915, 920, and 925. In accordance with the disclosed principles, service 105 is able to analyze image 910 and detect these OOIs. Service 105 then generates a bounding element that surrounds each of those OOIs. For instance, bounding element 930 is generated by service 105 and is shown as encompassing the pixel content associated with OOI 915; bounding element 935 is shown as encompassing the pixel content associated with OOI 920; and bounding element 940 is shown as encompassing OOI 925.

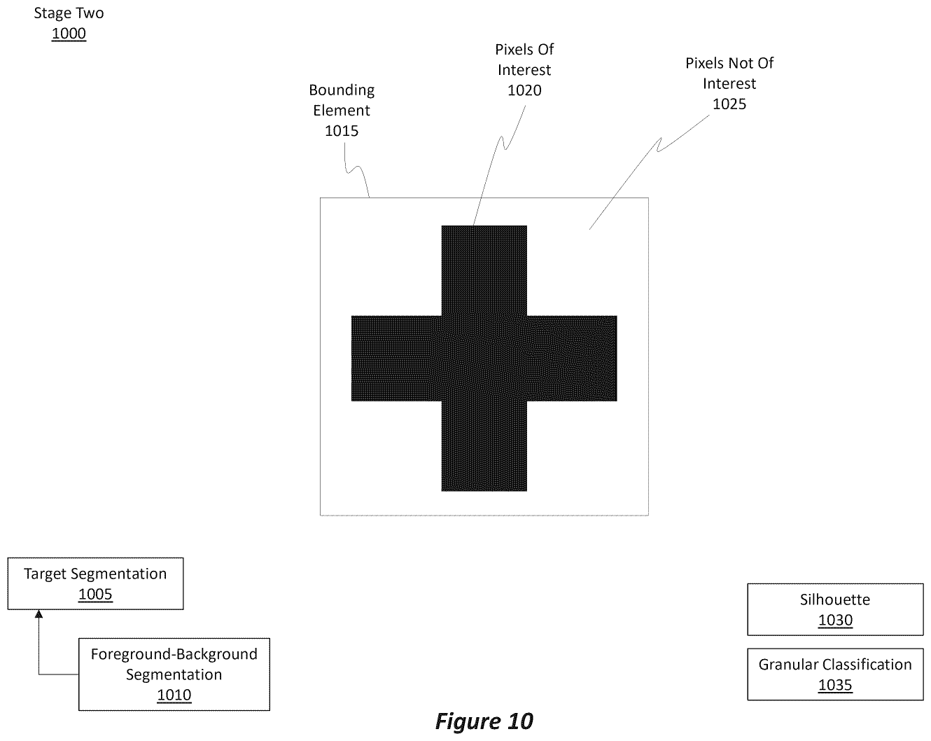

In stage one 900, image 910 is processed through an object detection algorithm to yield a set of bounding boxes around one or more targets or objects of interest (e.g., humans, animals, objects, etc.). Service 105 can optionally use a deep learning method (e.g., perhaps YOLO (You Only Look Once)) for this task as it is well suited to rapid, accurate object detection. Such deep learning models are economical enough to run on a variety of different devices, including laptops, HMDs, and so on. If the algorithm does not generate any boxes, image 910 may be automatically marked as a miss and skipped. The result may also be cross-referenced with global positioning system (GPS) data and orientation data of all the gaming session participants to determine if a target is likely to be in the field of view of the image. If the navigation data suggests targets are present but none are detected, image 910 may be set aside and marked for human review. If one or more bounding boxes are generated, the process can proceed to stage two, which is shown in FIG. 10.

FIG. 10 shows stage two 1000 of the process, which involves target segmentation 1005. In the case where the image is a thermal image, the target segmentation 1005 can be performed in a highly efficient manner using foreground-background segmentation 1010, where the “hot” pixels are foreground pixels, and the “cold” pixels are background pixels. Further details on this aspect will be provided later.

In any event, service 105 is tasked with granularly classifying only the pixels surrounded by a bounding element; service 105 does not granularly classify the pixels outside of the bounding elements. Thus, pixels that are not surrounded by a bounding element can be ignored. Stage one, therefore, involves an initial, high-level filtering operation to remove pixels that are not related to OOIs identified as being a specific type (e.g., a human, animal, etc.).

Service 105 analyzes the pixels surrounded by the bounding element 1015 and performs a granular classification on those pixels to determine what the group of pixels represent. To illustrate, FIG. 10 shows that the black pixels are pixels of interest 1020 while the white pixels are pixels not of interest 1025. Service 105 is able to classify the pixels of interest 1020 to determine what they collectively represent (e.g., in this case a cross). Service 105 can also perform a more granular classification by determining which subset of pixels represent which specific parts of the overall OOI.

For instance, the pixels on the right-hand side of the cross can be categorized as “right hand” portion of the cross. Using a human as an example, suppose the pixels of interest represented a human. The pixels of the human's arm can be classified as arm pixels. The pixels of the human's leg can be classified as leg pixels. Indeed, a sub-part or granular classification can be attributed to each pixel of interest as well.

Service 105 is also able to determine a silhouette 1030 or a border region of the OOI. With the human example, the human's silhouette can be recognized. Accordingly, service 105 is able to identify and classify the group of pixels, is able to identify a silhouette for the OOI, and is even able to perform a sub-part granular classification 1035 to determine what a subset of pixels corresponds to in the context of the overall OOI.

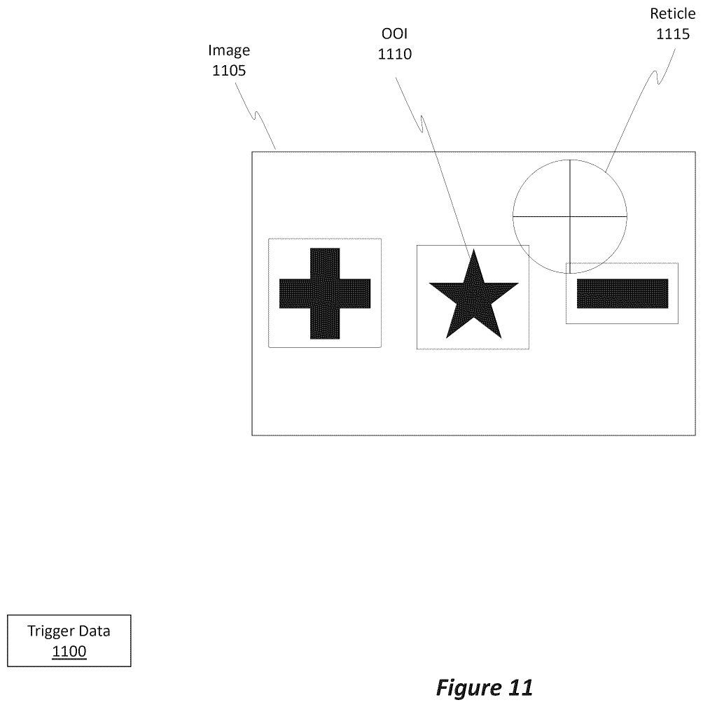

FIG. 11 shows an example scenario in which trigger data 1100 is obtained. In this scenario, a timestamp as to when the trigger was pulled is determined and is included in the trigger data 1100. When the trigger is pulled, service 105 is able to determine where the external camera is aimed. For instance, consider the image 1105, which includes an OOI 1110. Image 1105 is also showing a reticle 1115, which corresponds to the position where the external camera is being aimed. At the time the trigger is pulled, service can determine where the tool (which is associated with the external camera) is being aimed because the reticle 1115 corresponds to where the tool is being aimed (and further corresponds to where the external camera is being aimed). In the example shown in FIG. 11, the tool is not being aimed at any of the OOIs shown in the image.

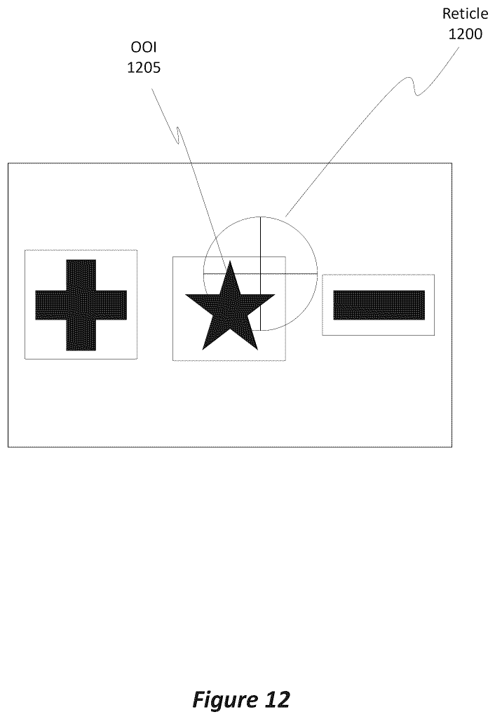

FIG. 12 now shows a scenario where the center of the reticle 1200 (and hence the tool) is now within the bounding element surrounding the OOI 1205, yet the center of the reticle is not overlapping the actual OOI 1205. Thus, if the trigger were pulled, then the OOI 1205 would not be targeted despite the center of the reticle 1200 falling within the bounding element.

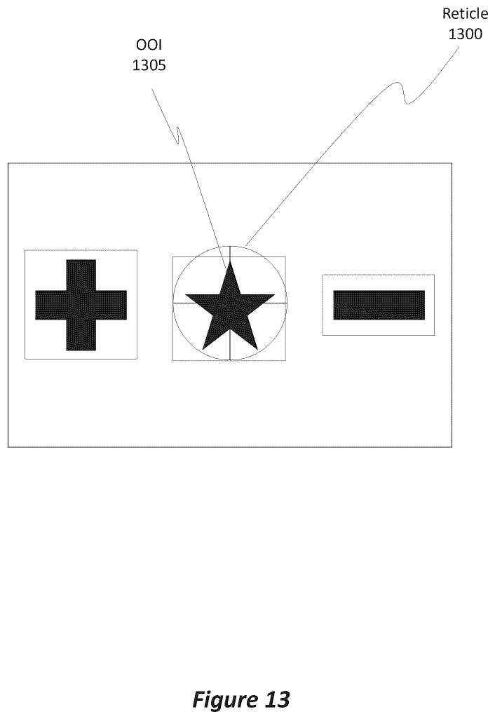

FIG. 13, on the other hand, now shows a scenario where the target would be hit. In this scenario, the center of the reticle 1300 overlaps the pixels that correspond to the OOI 1305. Thus, if the trigger were to be pulled, then the OOI 1305 would be properly targeted by the tool. Furthermore, inasmuch as the individual pixels were granularly characterized (e.g., based on sub-parts of the OOI), the embodiments can determine which specific portion of the OOI 1305 was hit when the trigger was pulled. Accordingly, the disclosed embodiments can assist in accurate targeting.

Referring back to stage two, one purpose of stage two is to improve the accuracy of determining whether a shot taken by a participant was a hit or a miss on the detected target. As shown by the example of FIG. 12, the center of the aiming reticle 1200 is inside the bounding element of a detected OOI 1205, but the center of the reticle 1200 does not actually intersect the silhouette of the OOI 1205. A bounding box is thus not sufficient to make an accurate judgement call as to whether a hit was landed. Stated differently, if the stage one detection alone was used to make an automated decision, that decision would not be sufficiently accurate. Further refinement is warranted. In stage two, the embodiments thus consider each sub-region of the image represented by the detected bounding elements from stage one separately and attempt to find the optimal segmentation separating foreground from background.

Segmentation algorithms can broadly be categorized into supervised methods (requiring training data) and unsupervised methods (need no training data). Supervised methods such as Mask-RCNN have a drawback of requiring large amounts of labeled training data, long training times, and intensive memory and computing resources to obtain the segmented results. Such algorithms are often not easy to run without a discrete graphics processing unit (GPU). This may be undesirable for applications that take place in remote locations and require lightweight, easy-to-transport hardware.

In the area of unsupervised methods, popular options include morphological methods such as flood-fill or the watershed algorithm. These have the benefit of being efficient but can be sensitive to noise and local optima in the regions of interest, resulting in segmented solutions that have holes and gaps. For the purpose of determining target accuracy, this is often not desirable.

Some embodiments disclosed herein use an unsupervised energy-minimization graph cut algorithm, such as the Boykov-Kolmogorov method, to efficiently segment the target/OOI once it has been detected by the first stage of the algorithm. This approach has a number of advantages.

One advantage is that the target has already been detected with a high confidence and is generally centered in the bounding box of interest. Another benefit (when dealing with thermal images) is that the image is in the thermal spectrum and can be expected to manifest as a predominantly white object against a black background (or vice-versa). The algorithm requires no training data and can be tuned using well-defined principles of combinatorics and statistics. The algorithm can be easily scaled for different resource constraints simply by resizing the image and performing segmentation at a lower resolution.

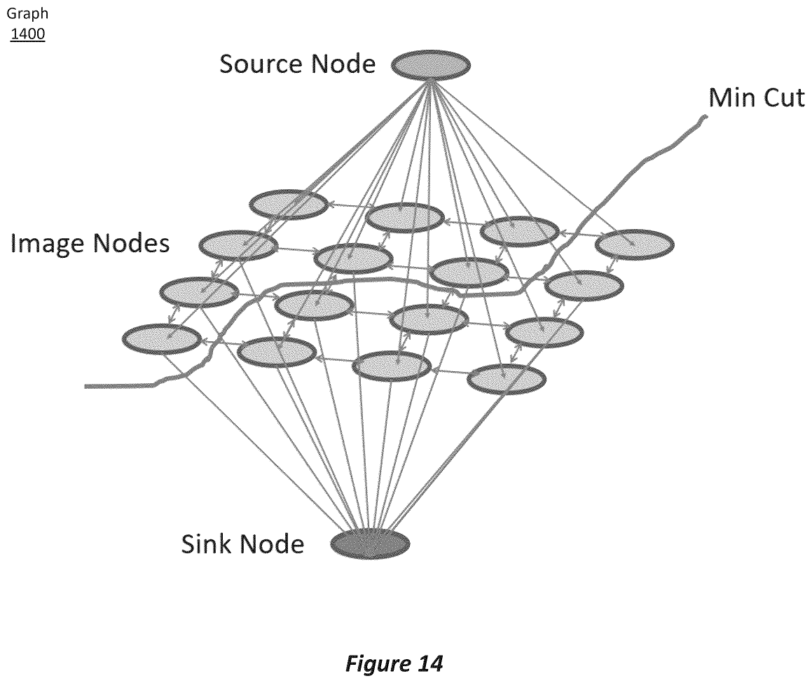

Graph cut algorithms attempt to minimize an energy cost metric by representing an image as a directed, fully connected graph 1400, as shown in FIG. 14. The nodes in graph 1400 consist of one node for every pixel in the image plus a source node(S) and sink node (T). S and T are connected to every pixel in the image by an edge, and each image pixel is connected to its neighboring pixels (4 or 8 if including corners), plus one edge connected to S and one connecting it to T. Additionally, each edge is bidirectional and can have different flows in each direction. The edges in the graph can be thought of as representing flow from the source to the sink, and the goal of a graph cut optimization is to find a path from S to T that maximizes the flow or, alternatively, finds the set of edges to cut (min cut) that divides the set of nodes into two discrete sets that minimizes the cost function. For the purposes of finding the global optimum solution, the max flow and min cut are equivalent concepts.

Some of the most popular methods of solving the graph cut problem are the augmenting path algorithms, of which Edmonds-Karp and Boykov-Kolmogorov are the most well-known examples. These typically iterate between searching the graph for a potential path between source and sink (growth step) and then modifying the residual flow through the path by subtracting the minimum flow through the path from each edge in the Source->Sink direction and adding the minimum flow in the Sink->Source direction. This continues until all paths are fully saturated and no further paths can be found. The min cut (or segmentation) of the graph is then found by tracing a simple depth-first search from the sink back to the source.

Optimizations to the augmenting path methods depend broadly on s number of considerations. One consideration involves the initial boundary penalty, or flow, between neighboring pixel edges. This can be thought of as a cost function. Another consideration involves search strategies to improve the speed of the algorithm and to ensure it terminates in a timely manner. Another consideration involves the initial flow between S and each pixel (foreground labels) as well as the initial flow between each pixel and T (background labels).

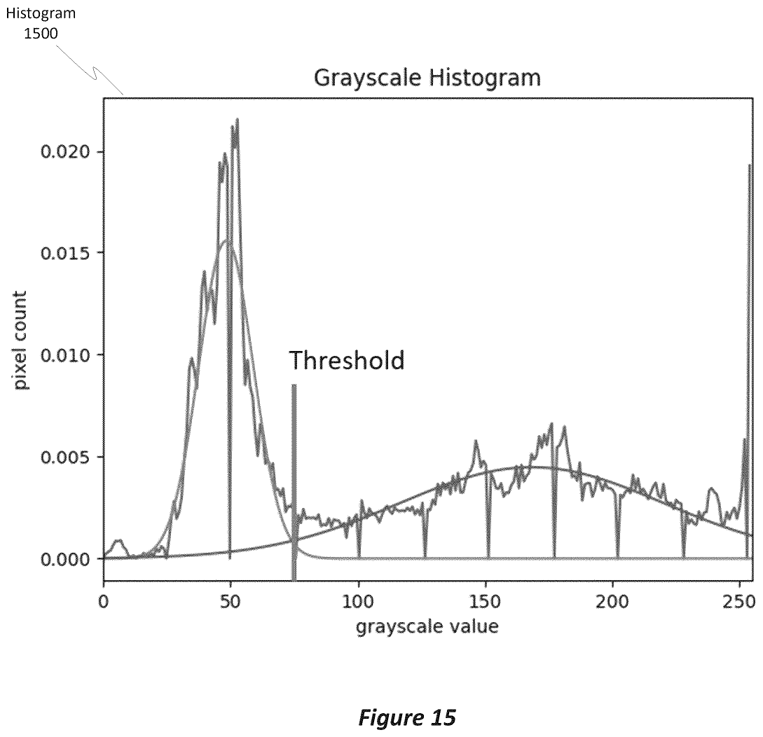

Typically, the initial flow connecting the Source and Sink to the pixel nodes in a graph are primed using user input. The “magic wand” in a photo editing tool is a good example of this. In such a scheme the user may draw some lines marking which parts of the image are “foreground” and which are “background.” Beneficially, the disclosed techniques can automatically make an initial educated guess. This is accomplished by generating a histogram from the grayscale values of the cropped image detection returned by stage one, as shown by the histogram 1500 of FIG. 15.

The embodiments then fit a Gaussian mixture model (GMM) of two components to the histogram using a method such as Expectation-Maximization (EM). This follows the assumption that, as the bounding box has already tightly cropped the target of interest, the pixel values of the image are likely divided into a “light” and “dark” group (e.g., when a thermal image is used). Note that the two groups do not need to be far apart in luminance. That is, as long as there is a statistically significant difference between the two distributions, the foreground and background can be similar in intensity. Fitting a mixture model gives the segmentation algorithm the capability of adapting to different levels of thermal contrast, which may change depending on time of day and environmental factors.

The Gaussian mixture model returns the mean, variance, and weight of each component. The weight allows the embodiments/service to scale the normal distribution of each component to account for the relative proportion of light vs. dark pixels (which may not be in perfect 50-50 distribution). Next, the embodiments find the pixel value that corresponds to the intersection between the two distributions. As normal distributions have multiple intersections, the embodiments find the intersection that lies between the two means. This value is the threshold below which a pixel “p” is more likely to be “dark” and above which it is more likely to be “light.” The embodiments use this threshold to prime the edges between the source node S and the pixels, and the pixels and the sink node T, respectively. Namely, the path from S->p will be given a saturating flow of 100 if Intensity (p) is below the threshold, and the path from p->T will be given a saturating flow if Intensity (p) is greater than or equal to the threshold. All other edges originating at S or T are given a flow of 0.

Before commencing stage two, the embodiments may optionally apply a median filter to the bounding box image crop. This serves a few purposes. One purpose is that it removes salt-and-pepper noise (which is a common feature of infrared cameras). Another purpose is that it reduces the variance of boundary penalties between image pixels in the segmentation graph. This tends to result in faster convergence of the graph cut algorithm as it will tend to follow the path of least resistance when searching for a max flow. Such operations beneficially result in a smoother edge to the foreground segmentation.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

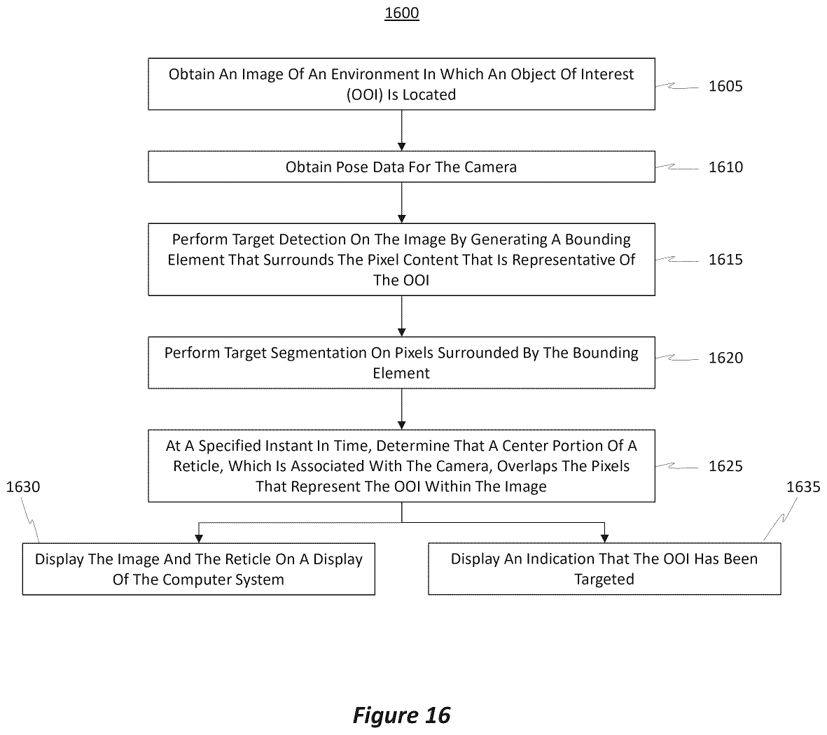

Attention will now be directed to FIG. 16, which illustrates a flowchart of an example method 1600 for determining whether an OOI has been properly targeted. Method 1600 can be implemented within the architecture 100 of FIG. 1. Furthermore, method 1600 can be implemented by service 105 of FIG. 1.

Method 1600 includes an act (act 1605) of obtaining an image (e.g., image 700 of FIG. 7) of an environment in which an object of interest (OOI) (e.g., any of OOIs 725, 730, or 735) is located. The image includes pixel content (e.g., pixel content 720) representative of the OOI, and the image is generated by a camera (e.g., any of the cameras shown in FIG. 7). In some scenarios, the image has a thermal spectrum and is manifested as having foreground pixels and background pixels. Optionally, the image may be an overlaid image that includes content obtained from the image (e.g., perhaps the thermal image) and a different image (e.g., perhaps an RGB image or a low light image or even another thermal image).

Act 1610 includes obtaining pose data (e.g., pose data 130 from FIG. 1) for the camera. The pose data represents a pose of the camera when the camera generated the image. The pose data can be obtained using IMU data (e.g., the pose data is generated using an IMU), using feature detection, using GPS data, or any other type of data to determine pose/orientation.

Act 1615 includes performing target detection (e.g., stage one) on the image. This act is performed by generating a bounding element (e.g., bounding element 930 in FIG. 9) that surrounds the pixel content that is representative of the OOI. In some implementations, the position of the bounding element is set so that the OOI is centered in the bounding element.

Optionally, the target detection may include use of a deep learning algorithm comprising a you-only-look-once (YOLO) algorithm. Optionally, the target detection may include cross-referencing the image with one or more of: global positioning system (GPS) data or orientation data of all OOIs in the image or environment.

Optionally, the target detection may include down-sampling at least some pixels surrounded by the bounding element. For instance, one or more down-sampling operations can be performed in an effort to reduce the amount of computations that the stage two operations will perform. That is, by reducing the number of pixels, the number of granular classifications performed in stage two can also be reduced, thereby further speeding up the process.

Subsequent to performing the target detection (e.g., stage one), act 1620 includes performing target segmentation (e.g., stage two) on pixels surrounded by the bounding element. Beneficially, performing the target segmentation is performed substantially in real-time.

The target segmentation identifies pixels that represent the OOI and pixels that do not represent the OOI. The target segmentation can also be used to identify a silhouette of the OOI. The target segmentation may include use of an unsupervised energy-minimization graph cut algorithm to segment the OOI.

Performing the target segmentation further includes granularly classifying each of the pixels that represent the OOI as a particular part of the OOI. When a thermal or high contrast image is available, the target segmentation may include a foreground-background segmentation stage using the graph 1400 of FIG. 14.

At a specified instant in time (e.g., when a trigger is pulled), act 1625 includes determining whether a reticle associated with the camera overlaps the pixels that represent the OOI within the image. Optionally, at the specified instant in time, the embodiments may determine one or more environmental conditions that are present within the environment. These conditions can be used to modify the visual placement of the reticle and/or modify the determination as to whether a shot landed. That is, the position of the reticle can optionally be adjusted based on one or more detected environmental conditions (e.g., wind speed, barometric pressure, altitude, humidity, precipitation, etc.) detected within the environment.

Optionally, determining whether the reticle associated with the camera overlaps the pixels that represent the OOI within the image may include determining whether a center-point of the reticle is within the bounding element. Optionally, determining whether the reticle associated with the camera overlaps the pixels that represent the OOI within the image may include determining whether the center-point of the reticle is within the bounding element and is further overlapping the pixels that represent the OOI.

Act 1630 includes displaying the image and the reticle on a display of the computer system. Act 1635 includes displaying an indication that the OOI has been targeted as a result of the center portion of the reticle overlapping the pixels that represent the OOI at the specified instant in time.

Method 1600 may further include an act of transmitting a notice to a computer system associated with the OOI. This notice can inform that other computer system that the OOI has been targeted. For instance, the computer system may be the HMD of the competitor who was targeted and hit. The HMD can thus inform the competitor regarding his/her hit status.

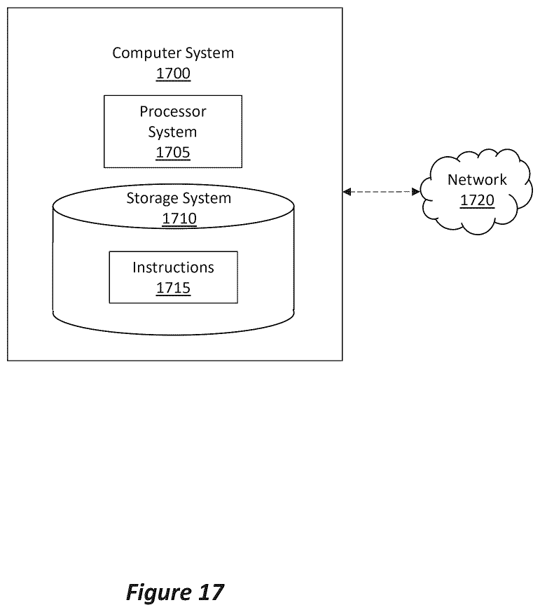

Attention will now be directed to FIG. 17 which illustrates an example computer system 1700 that may include and/or be used to perform any of the operations described herein. For instance, computer system 1700 can be in the form of the XR system 110 of FIG. 1 and can implement the service 105.

Computer system 1700 may take various different forms. For example, computer system 1700 may be embodied as a tablet, a desktop, a laptop, a mobile device, or a standalone device, such as those described throughout this disclosure. Computer system 1700 may also be a distributed system that includes one or more connected computing components/devices that are in communication with computer system 1700.

In its most basic configuration, computer system 1700 includes various different components. FIG. 17 shows that computer system 1700 includes a processor system 1705 that includes one or more processor(s) (aka a “hardware processing unit”) and a storage system 1710.

Regarding the processor(s), it will be appreciated that the functionality described herein can be performed, at least in part, by one or more hardware logic components (e.g., the processor(s)). For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “service,” or “engine” can refer to hardware processing units or to software objects, routines, or methods that may be executed on computer system 1700. The different components, modules, engines, and services described herein may be implemented as objects or processors that execute on computer system 1700 (e.g. as separate threads).

Storage system 1710 may be physical system memory, which may be volatile, non-volatile, or some combination of the two. The term “memory” may also be used herein to refer to non-volatile mass storage such as physical storage media. If computer system 1700 is distributed, the processing, memory, and/or storage capability may be distributed as well.

Storage system 1710 is shown as including executable instructions 1715. The executable instructions 1715 represent instructions that are executable by the processor(s) the processor system 1705 to perform the disclosed operations, such as those described in the various methods.

The disclosed embodiments may comprise or utilize a special-purpose or general-purpose computer including computer hardware, such as, for example, one or more processors and system memory, as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 1700 may also be connected (via a wired or wireless connection) to external sensors (e.g., one or more remote cameras) or devices via a network 1720. For example, computer system 1700 can communicate with any number devices or cloud services to obtain or process data. In some cases, network 1720 may itself be a cloud network. Furthermore, computer system 1700 may also be connected through one or more wired or wireless networks to remote/separate computer systems(s) that are configured to perform any of the processing described with regard to computer system 1700.

A “network,” like network 1720, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 1700 will include one or more communication channels that are used to communicate with the network 1720. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system comprising:
a processor system; and
a storage system comprising instructions that are executable by the processor system to cause the computer system to:
obtain an image of an environment in which an object of interest (OOI) is located, wherein the image includes pixel content representative of the OOI, the image being generated by a camera;
obtain pose data for the camera, the pose data representing a pose of the camera when the camera generated the image;
perform target detection on the image by generating a bounding element that surrounds the pixel content that is representative of the OOI;
subsequent to performing the target detection, perform target segmentation on pixels surrounded by the bounding element, wherein the target segmentation identifies pixels that represent the OOI and pixels that do not represent the OOI, and wherein the target segmentation identifies a silhouette of the OOI; and
determine whether a reticle associated with the camera overlaps the pixels that represent the OOI within the image.

2. The computer system of claim 1, wherein the image is one of a thermal image, a low light image, or a red-green-blue (RGB) image.

3. The computer system of claim 1, wherein the pose data is generated using an inertial measurement unit (IMU).

4. The computer system of claim 1, wherein performing the target segmentation is performed substantially in real-time.

5. The computer system of claim 1, wherein performing the target segmentation further includes granularly classifying each of the pixels that represent the OOI as a particular part of the OOI.

6. The computer system of claim 1, wherein the target segmentation includes a foreground-background segmentation stage.

7. The computer system of claim 1, wherein the instructions are further executable to cause the computer system to:
determine one or more environmental conditions that are present within the environment at a time when the image was generated.

8. The computer system of claim 1, wherein the target detection includes use of a deep learning algorithm comprising a you-only-look-once (YOLO) algorithm.

9. The computer system of claim 1, wherein the target detection includes cross-referencing the image with one or more of: global positioning system (GPS) data or orientation data of all OOIs, including said OOI, in the environment.

10. The computer system of claim 1, wherein determining whether the reticle associated with the camera overlaps the pixels that represent the OOI within the image includes determining whether a center-point of the reticle is within the bounding element.

11. The computer system of claim 10, wherein determining whether the reticle associated with the camera overlaps the pixels that represent the OOI within the image includes determining whether the center-point of the reticle is within the bounding element and is further overlapping the pixels that represent the OOI.

12. A method comprising:
obtaining an image of an environment in which an object of interest (OOI) is located, wherein the image includes pixel content representative of the OOI, the image being generated by a camera;
obtaining pose data for the camera, the pose data representing a pose of the camera when the camera generated the image;
performing target detection on the image by generating a bounding element that surrounds the pixel content that is representative of the OOI;
subsequent to performing the target detection, performing target segmentation on pixels surrounded by the bounding element, wherein the target segmentation identifies pixels that represent the OOI and pixels that do not represent the OOI, and wherein the target segmentation identifies a silhouette of the OOI; and
determining whether a reticle associated with the camera overlaps the pixels that represent the OOI within the image.

13. The method of claim 12, wherein the target segmentation includes use of an unsupervised energy-minimization graph cut algorithm to segment the OOI.

14. The method of claim 12, wherein a position of the bounding element is set so that the OOI is centered in the bounding element.

15. The method of claim 12, wherein the image has a thermal spectrum and is manifested as having foreground pixels and background pixels.

16. The method of claim 12, wherein the method further includes transmitting a notice to a computer system associated with the OOI informing the computer system that the OOI has been targeted.

17. The method of claim 12, wherein the target detection further includes down-sampling at least some pixels surrounded by the bounding element.

18. A computer system comprising:
a processor system; and
a storage system comprising instructions that are executable by the processor system to cause the computer system to:
obtain an image of an environment in which an object of interest (OOI) is located, wherein the image includes pixel content representative of the OOI, the image being generated by a camera;
obtain pose data for the camera, the pose data representing a pose of the camera when the camera generated the image;
perform target detection on the image by generating a bounding element that surrounds the pixel content that is representative of the OOI;
subsequent to performing the target detection, perform target segmentation on pixels surrounded by the bounding element, wherein the target segmentation identifies pixels that represent the OOI and pixels that do not represent the OOI, and wherein the target segmentation identifies a silhouette of the OOI;
determine that a center portion of a reticle, which is associated with the camera, overlaps the pixels that represent the OOI within the image;
display the image and the reticle on a display of the computer system; and
display an indication that the OOI has been targeted as a result of the center portion of the reticle overlapping the pixels that represent the OOI at the specified instant in time.

19. The computer system of claim 18, wherein the image is an overlaid image that includes content obtained from the image and a different image.

20. The computer system of claim 18, wherein a position of the reticle is adjusted based on one or more detected environmental conditions detected within the environment.
